(19) United States
(12) Patent Application Publication
(10) Pub. No.: US 2009/0272555 A1
(43) Pub. Date: Nov. 5, 2009

(54) PULSE MACHINE, METHOD FOR GENERATION OF MECHANICAL PULSES AND ROCK DRILL AND DRILLING RIG COMPRISING SUCH PULSE MACHINE

(75) Inventors: Risto Wisakanto, Fagersta (SE); Göran Tuomas, Orebro (SE)

Correspondence Address: MARK P STONE ATTORNEY AT LAW, 50 BROADWAY, HAWTHORNE, NY, 10532, US

(73) Assignee: ATLAS COPCO ROCKDRILLS AB

(21) Appl. No.: 12/312,196

(22) PCT Filed: Nov. 5, 2007
(86) PCT No.: PCT/SE2007/050818

§ 371 Date: Apr. 29, 2009

(30) Foreign Application Priority Data
Nov. 16, 2006 (SE) 0602435-0

(51) Int. Cl. B25D 9/06; B06B 1/08; B25D 17/02; E21B 1/28

(52) U.S. Cl. 173/201; 91/317; 175/296; 91/248; 91/249

(57) ABSTRACT

According to one aspect of the invention hydraulic pressure pulses are created in a rock drill machine utilizing a rod (7, 7a, 7b) made of a magnetostrictive material arranged in one or more actuators (5, 5a, 5b), which exposes an impulse piston (3) in a pulse cylinder (1) to said hydraulic pressure pulses, whereby mechanical pressure pulses being transferred to a drill steel of the rock drill machine are generated in the impulse piston (3).

### TECHNICAL FIELD

The present invention relates to a device and a method for generating pressure pulses in an impulse machine, preferably used in a rock drill machine, wherein a rod made of a magnetostrictive material periodically generates pressure pulses in a liquid, whereby the repetitively recurrent pressure pulses act on an impulse piston to exert impulses on a bore string.

### TECHNICAL BACKGROUND

In prior art technology a pressure pulse is generated in a striking mechanism by utilizing a reciprocating striking piston, which at the end of a piston movement hits a rear end of a drill steel. By this, a pressure pulse propagating through the drill steel towards the material being machined is generated. Herein, the concept drill steel also denotes a bore string, which in turn may be composed of one or more connected drill rods or drill tubes, in its foremost end usually provided with a drill bit. The oscillating movement, which the reciprocating striking piston performs, is usually generated by a pressure medium provided in a pressure chamber to periodically exert a high pressure on the piston, whereby said high pressure makes the piston to move axially and in turn exert strikes on the rear end of the drill steel or on an adapter arranged for this purpose on the drill steel, to which the adapter is coupled. For the creation of the periodically alternating pressure, a pump is used for the generation of a high pressure in a hydraulic liquid. A slide controls a flow of the pressurized hydraulic liquid to exert the periodical pressure actively acting on the striking piston.

An example of prior art in the field can be found by reference to document WO2005/080051 A1. On use of such conventional technology the possibilities to control the parameters of the pressure pulses, such as frequency, pulse width etc. are limited.

An alternative example of prior art to accomplish pressure pulses acting on the drill steel by use of the striking mechanism can be found by reference to document WO2004/060617. In this document it is stated that, instead of using a striking piston moving backwards and forwards under the influence of a pressure medium, another type of element can be used to create the desired pressure pulses. It is stated that such an alternative, as an example, is a material based on the magnetostrictive effect generating the pressure pulses, i.e. the striking piston normally performing strikes on the drill steel, or its equivalence, is exchanged by a corresponding rod made from a magnetostrictive material. In said document and other documents disclosing corresponding technology, it is then being referred to a striking mechanism, wherein a rod made from a magnetostrictive material transfers pressure pulses to the drill steel directly by bearing against the shank of the drill steel. A rod of a magnetostrictive material, such as e.g. terfenol, withstands very small tension load, as it is a brittle material, whereby problems arise if the rod is used, for example, in connection with direct mechanical strikes.

An object of the present invention is to provide a solution to the drawbacks of the prior art.

### SUMMARY OF THE INVENTION

According to one aspect of the present invention a device characterized according to the enclosed claim 1 is presented.

According to a further aspect of the invention a method characterized according to the enclosed independent method claim is presented.

Further embodiments of the invention are disclosed in the dependent claims.

According to one aspect of the invention there is an object to create pressure pulses in a pulse machine utilizing magnetostrictive materials. One example of such a material is Terfenol-d. Magnetostrictive materials change their shape in the presence of magnetic fields, wherein a certain part of the energy of the magnetic field is transformed to mechanical energy being consumed at the reshape of the material. The, so called, coupling factor, that is the efficiency, between magnetic and mechanical energy is about 75%. By having the mechanical shape shift of the magnetostrictive material acting on a liquid in a liquid content, e.g. water or oil, pressure pulses can be created. These pressure pulses are finally used to generate mechanical pressure pulses in a drill steel.

Some of the advantages with a generation of pressure pulses for use in a pulse machine of the type as characterized in the invention are:
pulse control/pulse forming of electrical pulses can be used for the control of the pressure pulses,
a pulse machine of the type described will be significantly more silent than a corresponding striking mechanism of the conventional type,
the efficiency becomes high,
by control of the strikes, a possibility to attain an active damping is achieved (as an example, there is a possibility to control the length of the magnetostrictive rod to regulate a counter pressure behind the impulse piston),
the striking mechanism is electrically operated.

### BRIEF DESCRIPTION OF THE DRAWINGS

FIG. 1 schematically shows in a view the principle for a pulse machine provided with a pressure chamber containing an impulse piston and with a working cylinder containing a rod of a magnetostrictive material.

FIG. 2 schematically shows a view of a pulse machine as of FIG. 1 but provided with two working cylinders connected to the pressure chamber via two hydraulic conduits of different lengths.

FIG. 3 schematically shows a view of the same pulse machine as of FIG. 2 but provided with non-return valves for hydraulic fluid at the working cylinders and furthermore provided with drainage to a tank.

FIG. 4 schematically shows a view of the pulse machine of FIG. 2, wherein a pressure sensor is arranged to detect the pressure at the pressure chamber for the purpose of controlling electrical pulses to coils at the working cylinders respectively by means of feedback control.

### EMBODIMENTS

A number of embodiments of the invention are described in the following with the support of the enclosed drawings.

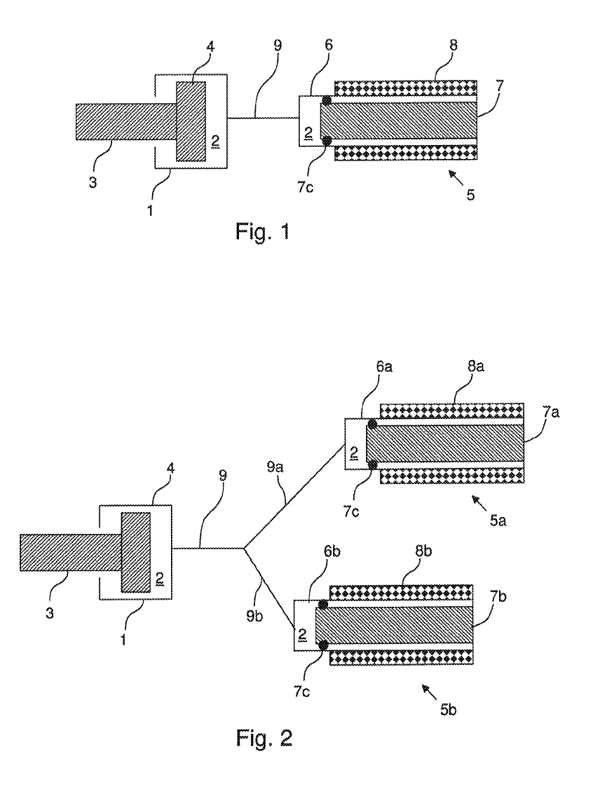

In FIG. 1 a fundamental principle of a pulse machine based on a magnetostrictive actuator is depicted. The left component symbolizes a pulse cylinder 1, which contains a room filled with a hydraulic fluid 2, which appropriately is composed of oil, whereas also other liquids, such as water, can be used. An impulse piston 3 is arranged so that at least a part of the impulse piston 3 formed as a piston head 4 is situated inside said room, thus being surrounded by the hydraulic fluid 2. As previously mentioned the task for the impulse piston 3 is to transfer mechanical pressure pulses to a drill steel. In certain embodiments the mechanical pressure pulses are transferred to an adapter provided between said drill steel and the impulse piston 3.

To the right in FIG. 1 an actuator 5 comprising a cylinder, herein called a working cylinder 6, is shown. The working cylinder encloses a rod 7 made of a magnetostrictive material. The rod 7 is, according to the example, sealed against the space between the envelope surface of the rod 7 and the inner wall of the working cylinder by means of a seal 7c. Ahead of the short side of the rod 7 a space is formed inside the working cylinder, wherein said room contains hydraulic fluid 2. Around the working cylinder 6, essentially along the length of the magnetostrictive rod 7, an electrical coil 8 is mounted for the generation of a magnetic field, within which the rod 7 will be situated.

Between the pulse cylinder 1 and the actuator 5 a conduit 9 is extended, whereby the hydraulic fluid 2 in the pulse cylinder 1 and the hydraulic fluid 2 in the working cylinder of the actuator 5 can communicate which each other.

When an electric current pulse is sent through the coil 8 a magnetic field is generated, in a known way, in the coil, whereby a powerful magnetic flux acts along the magnetostrictive rod 7. From the influence of the magnetic flux a change of the shape of the magnetostrictive rod 7 arises, so that it, e.g., expands axially at an increasing magnetic field and contracts axially at decreasing magnetic field. Hence, when such an electric current pulse, during increasing energy of the pulse, is conveyed to the coil 8, the length of the magnetostrictive rod 7 increases, whereby a hydraulic pressure pulse is created in the fluid 2. Said hydraulic pressure pulse is propagated via the conduit 9 to the pulse cylinder 1, where the hydraulic pressure pulse hits the head 4 of the impulse piston 3, whereby a mechanical pressure pulse is generated in the impulse piston 3, a pressure pulse which in its axial direction acts on a drill steel, or a drill steel connected to the impulse piston, bearing against the impulse piston. An adapter for the drill steel may exist between the impulse piston and the drill steel. In a corresponding way, when the energy of the current pulse decreases, the length of the magnetostrictive rod 7 becomes reduced. However, at the same time the impulse piston 3 has become influenced by a recoil force due to mechanical pressure pulse conveyed to the drill steel, which implies that the pulse time of the current pulse has to be adapted to the recoil force and the capability of the hydraulic fluid to fill up the space ahead of the rod 7 inside the working cylinder 6 without cavities forming in the fluid 2 at the return of the impulse piston 3 after an accomplished transferred mechanical pressure pulse.

Current pulses are supplied by use of power electronics, which are not further discussed here as such technology is well known in the art. As one example of power electronics for controlling periodically activated rods of a magnetostrictive material, it is herein referred to the electrical drive system in document U.S. Pat. No. 4,927,334.

In FIG. 2 an alternative embodiment of a pulse machine according to the invention is shown, wherein two actuators 5a and 5b are used. Conduits 9a and 9b from the actuators, respectively, leading to the pulse cylinder 1 have, in the shown example, different lengths. By this, electric pulses can be supplied to the two actuators 5a and 5b and be dispatched at different points of time. Those hydraulic pressure pulses generated in the actuators 5a, 5b, respectively, corresponding to the electric pulses are anyhow arranged to reach the common pulse cylinder 1 at the same time, as the lengths of the two conduits 9a and 9b are adapted to this. An advantage with this arrangement is that an associated drive system arranged to create electric control pulses can be designed for a lower power required and will therefore become cheaper than if two actuators are activated at the same point of time. The shown principle can, of course, be applied at systems with more than two actuators being controlled by pulses at different points of time and wherein hydraulic conduits 9 are performed with different lengths. It should be mentioned here that FIGS. 1 and 2 only shows conceptual embodiments of the device according to the aspect of the invention. In practice further details must be added to arrive at a working performance, such as preventing leakage and heating of hydraulic fluid. Further, it should be mentioned here that hydraulic pulses generated at different actuators 5a, 5b must not necessarily arrive at the impulse piston 3 at the same time. The possibility to control the point of time for the hydraulic pressure pulses can be utilized to control hydraulic pressure pulses from different actuators and/or generated at different points of time to cooperate with each other to build a desired pulse form of the hydraulic pressure pulse at the impulse piston 3.

A further possibility to reduce the size and required power of the drive system, without utilizing many actuators, is to construct a system with, say, two actuators, a first actuator 5a and a second actuator 5b, wherein these have different lengths of hydraulic conduits 9a and 9b and further to provide the system with two operating positions, wherein these operating positions are shifted by means of a valve. In a first operating position both said different hydraulic conduits 9a and 9b are extended with a length, which implies that a first and a second electric drive pulse to the first 5a and the second 5b actuator, respectively, generate corresponding first and second hydraulic pressure pulses, which reach the pulse cylinder 1 at the same point of time. After this, the valve is shifted to a second operating position, wherein the extended length of the hydraulic conduits are disconnected, whereupon a third and a fourth electric drive pulse are arranged so that their corresponding third and fourth hydraulic pressure pulses arrive at the pulse cylinder I at the same point of time and, furthermore, at the same point of time as when the first and second hydraulic pressure pulses, being generated by the first and second electric drive pulses from the drive system, arrive at the pulse cylinder 1. Through this arrangement four hydraulic pressure pulses can arrive at the impulse piston 3 in the pulse cylinder at the same point of time, although only two actuators 5a and 5b are available and where four electric drive pulses of lower power are generated than what would be required to accomplish a corresponding hydraulic pressure force on the impulse piston 3 with four actuators without the described control and the shift between two operating positions. By this, powerful hydraulic pressure pulses can be accomplished using a limited power electronics structure with respect to power required.

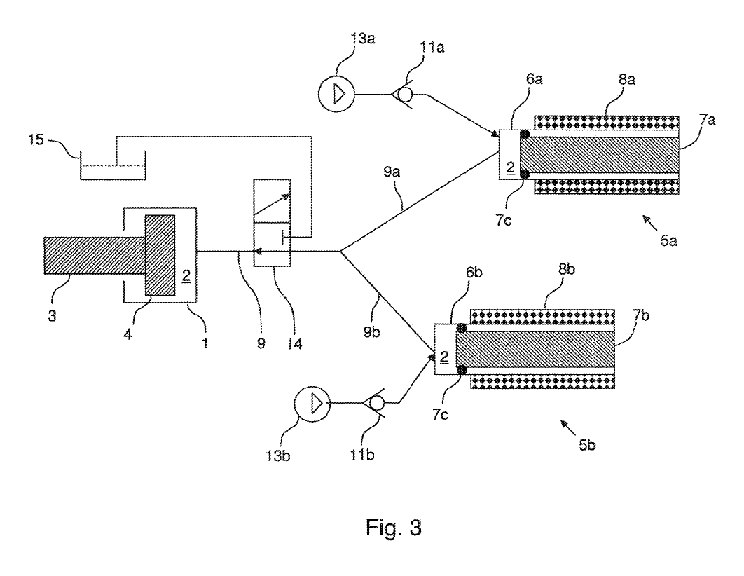

In order to, as previously stated, avoid cavitations in the system, i.e. a formation of gas bubbles in the hydraulic fluid, non-return valves can be installed according to FIG. 3. These non-return valves 11a, 11b are positioned in conduits 9a, 9b, which couples a first pump 13a and second pump 13b for hydraulic fluid 2 to the respective associated working cylinder 5a, 5b. When the length of the magnetostrictive rods 7 are reduced, owing to their change of shape, fluid 2 will flow from the respective associated pump 13a, 13b in to the respective associated working cylinder 5a, 5b via the non-return valves 11a, 11b. It is further possible to arrange the pumps 13a, 13b to provide a minimum pressure for the hydraulic fluid 2 to provide that a maximal permitted traction force of the magnetostrictive rods 7a, 7b is not exceeded.

In FIG. 3 there is further shown a hydraulic valve 14, which is shifted between a first position, wherein hydraulic pressure pulses advance through the conduits 9a, 9b on their way towards the pulse cylinder 1, and a second position, wherein the impulse piston 3 has transferred a mechanical pressure pulse to the drill steel. When the impulse piston 3 has transferred the mechanical pressure pulse, it will be brought back owing to a recoil from the feeding force and recoil forces from the rock or another boring object. During this time, i.e. when the impulse piston 3 is recoiled after a transferred mechanical pressure pulse, fluid 2 is evacuated from the pulse cylinder 1 to a tank 15. Furthermore, by supplying a hydraulic fluid 2 from the pumps 13a, 13b to the working cylinder 6 and draining the hydraulic fluid 2 to the tank 15, a through flow of hydraulic fluid 2 in the system is obtained, whereby an overheating of the hydraulic fluid 2 is counteracted.

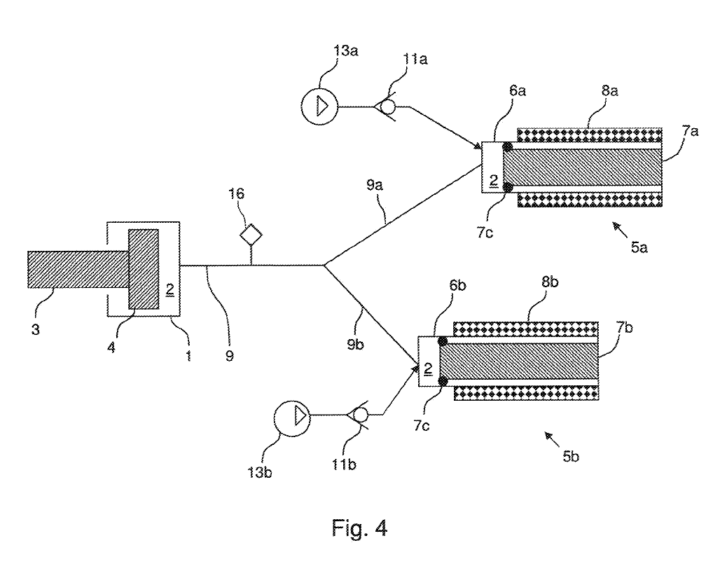

FIG. 4 shows that there is further a possibility to actively control the drive pulses to the actuators 5a, 5b. By positioning a pressure sensor 16 in connection with the conduit 9, interconnecting working cylinder and pulse cylinder, information from the pressure sensor is obtained about the hydraulic pressure pulse in the conduit 9. When the pressure is raised according to the pressure sensor 16 the lengths of the rods 7a, 7b are reduced as the magnetic field controlling the change of shape of the rods is lowered. The current in the coils 8a, 8b can be controlled by a drive system, which uses the PWM-technology (Pulse Width Modulation). The reaction time at changes of shape, i.e. how quickly a magnetostrictive rod responds to the changes of the electric drive pulses, is about micro seconds. The embodiment according to FIG. 4 can further be used to control the characteristics of the electric drive pulse and hence its shape of curve. Thus, a drive system utilizing PWM can be used to adapt the magnetic field and thereby electric drive pulses to the demands of different types of drilling machines. The embodiment including a sensor 16 for the detection and control of the hydraulic pressure pulses can of course be applied at the embodiment of FIG. 3 discussed above or in combination with more than two actuators. The sensor 16 can, alternatively, be positioned in the wall of the pulse cylinder 1.

In the figures the seal 7c, which as mentioned seals the space ahead of the magnetostrictive rod 7 in the working cylinder 5 against a space along the envelope surface of said rod is shown. The seal 7c is arranged such that the axial change of length of the magnetostrictive rod 7 shall provide for an optimal change of volume of the space ahead of the rod 7 at the change of length.

1. A pulse machine for a drill machine comprising a pulse cylinder with an impulse piston contained therein and the pulse cylinder containing a fluid, wherein the pulse machine further comprises:
at least one actuator including a working cylinder containing the same fluid as the pulse cylinder, a rod made of a magnetostrictive material enclosed in the working cylinder and an electric coil arranged to surround the working cylinder, and
a conduit through which the working cylinder is fluidly communicating with the pulse cylinder, wherein said electric coil is arranged to receive electric control pulses for the generation of a magnetic field and wherein said magnetostrictive rod is arranged to be controlled by the magnetic field to go through periodic changes of length to thereby generate corresponding periodic hydraulic pressure pulses in the fluid, wherein said hydraulic pressure pulses are arranged to propagate via the conduit to the impulse piston, wherein said impulse piston is arranged to generate, concurrently with said hydraulic pressure pulses, mechanical pressure pulses being transferred to a drill steel of the drill machine.

2. The pulse machine according to claim 1, wherein the pulse machine comprises a first actuator and a second actuator, wherein the first actuator is fluidly communicating with the pulse cylinder via a first conduit and the second actuator is fluidly communicating with the pulse cylinder via a second conduit, whereby the length of said first conduit and the length of said second conduit are adapted to each other such that an hydraulic pressure pulse from the first actuator and an hydraulic pressure pulse from the second actuator arrive at the pulse cylinder at the same point of time.

3. The pulse machine according to claim 1, wherein the conduit between an actuator and the pulse cylinder is provided with an hyrdraulic valve shifting between a first position and a second position, whereby the pulse cylinder in said second position is drained to a tank for the hydraulic fluid.

4. The pulse machine according to claim 1, wherein a pump is supplying hydraulic fluid to the actuator.

5. The pulse machine according to claim 4, wherein a non-return valve is arranged between the pump and the actuator.

6. The pulse machine according to claim 1, wherin a pressure sensor is arranged in the conduit or in the pulse cylinder for the detection of a value of the pressure of the hydraulic fluid.

7. The pulse machine according to claim 6, wherein the detected value of the pressure is used for the control of the current in the electric coil for determining a wave form of said pressure pulses.

8. A method for the generation of mechanical pressure pulses of an impulse piston in a pulse machine for use in a drill machine, including the steps of:
electric control pulses are generated in a drive system,
a magnetic field is created and controlled by said electric control pulses,
a magnetostrictive rod is controlled by said magnetic field to perform periodic changes of its length,
hydraulic pressure pulses are generated in a hydraulic fluid as a result of the changes of length of the magnetostrictive rod,
magnetic pressure pulses are generated in the impulse piston when it is exposed to said hydraulic pressure pulses, whereby the impulse piston in turn transfers said mechanical pressure pulses to a drill steel of the drill machine.

9. The method according to claim 8, further including the step of:
different hydraulic pressure pulses from at least two actuators are controlled to arrive at the impulse piston at predetermined. points of time to cooperate and to create a predetermined curve shape of a resulting hydraulic pressure pulse reaching the impulse piston.

10. A rock drilling machine comprising the pulse machine of claim 1.

11. A drilling rig comprising at least one rock drill machine according to claim 10.

12. The pulse machine according to claim 2, wherein the conduit between an actuator and the pulse cylinder is provided with an hyrdraulic valve shifting between a first position and a second position, whereby the pulse cylinder in said second position is drained to a tank for the hydraulic fluid.

13. The pulse machine according to claim 2, wherein a pump is supplying hydraulic fluid to the actuator.

14. The pulse machine according to claim 13, wherein a non-return valve is arranged between the pump and the actuator.
